(19) United States
(12) Patent Application Publication
(10) Pub. No.: US 2025/0225627 A1
(43) Pub. Date: Jul. 10, 2025

(54) IMAGE ASPECT RATIO ENHANCEMENT USING GENERATIVE AI

(71) Applicant: Samsung Electronics Co., Ltd., Suwon-si (KR)

(72) Inventors: Anirudh Rao, San Jose, CA (US); Tomasz J. Palczewski, Danville, CA (US); Yingnan Zhu, Irvine, CA (US); Hong-Hoe Kim, Aliso Viejo, CA (US); Chaitanya Praveen Pratury, Mountain House, CA (US)

(21) Appl. No.: 18/409,496

(22) Filed: Jan. 10, 2024

(51) Int. Cl. G06T 5/77; G06T 5/60; G06T 5/70; G06T 7/00

(52) U.S. Cl. CPC G06T 5/77; G06T 5/60; G06T 5/70; G06T 7/0002; G06T 2207/20084; G06T 2207/30168

(57) ABSTRACT

A method includes adding an outpaint mask to an image to generate a masked image. The method also includes processing the image using an encoder neural network to generate an image representation of the image in a latent space. The method further includes processing the masked image using a convolution neural network and adding the image representation to generate an image embedding. The method also includes processing the image representation and the image embedding using at least one of a diffusion model and an interpolation process to generate a noisy latent image representation. The method further includes using a large language model to contextualize an outpainting prompt. The method also includes denoising the noisy latent image representation based on the contextualized outpainting prompt to generate a denoised latent image representation. In addition, the method includes processing the denoised latent image representation using a decoder neural network to generate an outpainted image.

### TECHNICAL FIELD

This disclosure relates generally to machine learning systems and processes. More specifically, this disclosure relates to image aspect ratio enhancement using generative artificial intelligence (AI).

### BACKGROUND

Ultrawide displays are becoming increasingly popular among users, and future television products and other display products will also likely leverage wider displays. The majority of the devices used today to display images or videos support much lower aspect ratios, such as 4:3 and 16:9. The adoption of ultrawide displays may hamper viewing experiences of users because of the mismatch in content alignment. Gamers, content creators, streaming-app enthusiasts, and others want to leverage the entire real estate provided on display screens. Additionally, generating new content presents a challenge with temporal consistency. Delivering a seamless high-quality visual experience under changing conditions remains an open problem with ultrawide displays.

### SUMMARY

This disclosure relates to image aspect ratio enhancement using generative artificial intelligence (AI).

In a first embodiment, a method includes adding an outpaint mask to an image to generate a masked image. The method also includes processing the image using an encoder neural network to generate an image representation of the image in a latent space. The method further includes processing the masked image using a convolution neural network and adding the image representation to generate an image embedding. The method also includes processing the image representation and the image embedding using at least one of a diffusion model and an interpolation process to generate a noisy latent image representation. The method further includes using a large language model to contextualize an outpainting prompt. The method also includes denoising the noisy latent image representation based on the contextualized outpainting prompt to generate a denoised latent image representation. In addition, the method includes processing the denoised latent image representation using a decoder neural network to generate an outpainted image. In another embodiment, a non-transitory machine readable medium includes instructions that when executed cause at least one processor of an electronic device to perform the method of the first embodiment.

In a second embodiment, an electronic device includes at least one processing device that is configured to add an outpaint mask to an image to generate a masked image. The at least one processing device is also configured to process the image using an encoder neural network to generate an image representation of the image in a latent space. The at least one processing device is further configured to process the masked image using a convolution neural network and add the image representation to generate an image embedding. The at least one processing device is also configured to process the image representation and the image embedding using at least one of a diffusion model and an interpolation process to generate a noisy latent image representation. The at least one processing device is further configured to use a large language model to contextualize an outpainting prompt. The at least one processing device is also configured to denoise the noisy latent image representation based on the contextualized outpainting prompt to generate a denoised latent image representation. In addition, the at least one processing device is configured to process the denoised latent image representation using a decoder neural network to generate an outpainted image.

In a third embodiment, a method includes performing a neural network architecture search using a noisy image and an initial student model to select a neural network architecture for an output student model. The neural network architecture for the output student model is selected according to a proxy prediction model based on a teacher model and the noisy image. The method also includes quantizing weights of the output student model, where outlier weights are quantized with a first precision higher than a second precision utilized for quantizing remaining weights other than the outlier weights. The method further includes clustering the weights of the output student model, where each neuron of a weight matrix for the output student model is represented by an integer cluster index for a centroid of clustered weights including a weight for the neuron. In another embodiment, an electronic device includes at least one processing device that is configured to perform the method of the third embodiment. In yet another embodiment, a non-transitory machine readable medium includes instructions that when executed cause at least one processor of an electronic device to perform the method of the third embodiment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example pipeline for image outpainting border regions of a display in accordance with this disclosure;

FIGS. 3A and 3B illustrate an example process for implementation of the pipeline of FIG. 2 in accordance with this disclosure;

FIG. 4 illustrates an example structure and example operation of an outpainting model of FIG. 2 in accordance with this disclosure;

FIG. 5 illustrates an example fitting of an input image to an outpainting canvas during the process of FIGS. 3A and 3B in accordance with this disclosure;

FIG. 6 illustrates example operation of an image-to-text model of FIG. 2 used for prompt extraction during the process of FIGS. 3A and 3B in accordance with this disclosure;

FIG. 7 illustrates an example image-to-text model, an example prompt engineering, and an example personalization block of FIG. 2 in accordance with this disclosure;

FIG. 8 illustrates an example training of a chain-of-thought prompt model in accordance with this disclosure;

FIG. 9 illustrates an example image quality detector of FIG. 2 used to calculate an image quality score during the process of FIGS. 3A and 3B in accordance with this disclosure;

FIGS. 10 and 10A illustrate an example vision transformer, multi-layer perceptron, and sigmoid function of FIG. 9 in accordance with this disclosure;

FIGS. 11 and 11A illustrate another example image quality detector of FIG. 2 used to calculate an image quality score during the process of FIGS. 3A and 3B in accordance with this disclosure;

FIGS. 12A and 12B illustrate another example process for implementation of the pipeline of FIG. 2 in accordance with this disclosure;

FIG. 13 illustrates an example structure and example operation of an outpainting model used in the process of FIGS. 12A and 12B in accordance with this disclosure;

FIGS. 14A and 14B illustrate yet another example process for implementation of the pipeline of FIG. 2 in accordance with this disclosure;

FIG. 15 illustrates an example structure and example operation of an outpainting model used in the process of FIGS. 14A and 14B in accordance with this disclosure;

FIG. 16 illustrates an example student teacher framework in accordance with this disclosure;

FIG. 17 illustrates a specific example implementation of the student teacher framework of FIG. 16 in accordance with this disclosure;

FIG. 18 illustrates an example quantization from a model optimization framework of FIG. 2 and an example of applying quantization fine-tuning during the process of FIGS. 3A and 3B in accordance with this disclosure;

FIGS. 19 and 20 illustrate an example weight sensitivity analysis by a model optimization framework of FIG. 2 and an example weight sensitivity analysis during the process of FIGS. 3A and 3B in accordance with this disclosure; and

FIG. 21 illustrates an example weight clustering by a model optimization framework of FIG. 2 and an example weight clustering during the process of FIGS. 3A and 3B in accordance with this disclosure.

### DETAILED DESCRIPTION

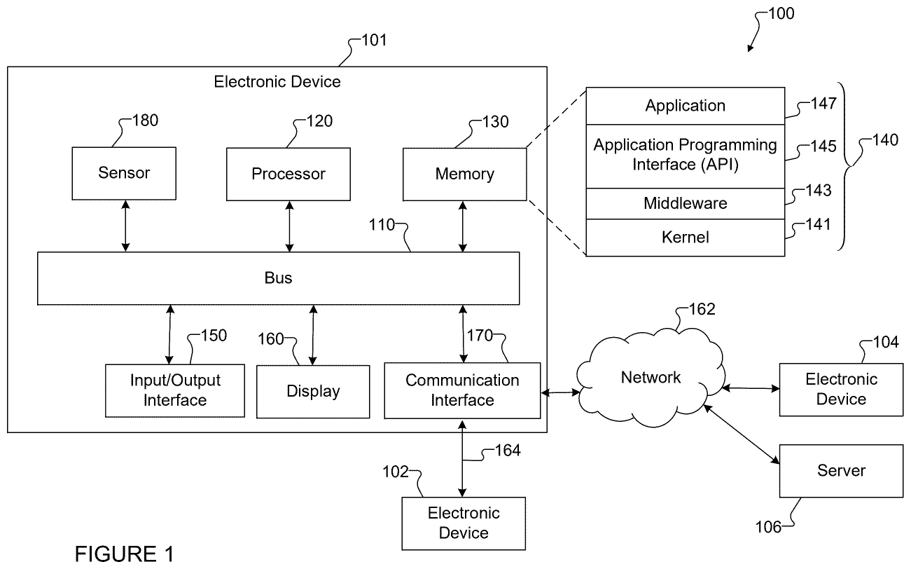

FIGS. 1 through 21, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, ultrawide displays are becoming increasingly popular among users, and future television products and other display products will also likely leverage wider displays. The majority of the devices used today to display images or videos support much lower aspect ratios, such as 4:3 and 16:9. The adoption of ultrawide displays may hamper viewing experiences of users because of the mismatch in content alignment. Gamers, content creators, streaming-app enthusiasts, and others want to leverage the entire real estate provided on display screens. Additionally, generating new content presents a challenge with temporal consistency. Delivering a seamless high-quality visual experience under changing conditions remains an open problem with ultrawide displays.

Recently, generative artificial intelligence (AI) technology has shown promise in the text-to-image generation domain. Specifically, diffusion-based models (such as Stable Diffusion from RunwayML) have exhibited exceptional ability with contextually understanding input prompts and inpainting or outpainting images with high fidelity and quality. The use of large language models (LLMs) in generating appropriate prompts is a powerful tool in ensuring consistency between the original content and the generated content. Leveraging generative AI could consistently enhance a user's viewing experience in ultrawide viewing.

Unfortunately, large diffusion-based models are memory intensive and potentially require a lot of processing power on a device. Model compression is an active area of research and provides opportunities to optimize model performance and space requirements to deploy on devices. Moreover, outpainted regions on an ultrawide screen can also be utilized for other purposes, such as to target customers with custom ads and brand placement based on viewing behaviors and personalized interactions on devices. The embedded content recognition technology within smart televisions (TVs) allows monitoring of user behaviors and provides a holistic understanding of users' viewing preferences. Among other things, outpainted content can be paired with this information to strategically place ads relevant for a user.

Currently-available smart TVs or other big-screen devices do not support image outpainting capabilities. Multiple problems arise when trying to use such models on TVs or other big-screen devices. For example, the majority of outpainting models used for outpainting tasks are trained on very specific and small datasets and may be biased or limited in the content that can be generated. Also, the model size is a constraint to scaling such models. Since memory space on a device can be limited and memory can be shared across different applications, ensuring that the model is optimized for on-device usage can be useful or important. Moreover, enhancing the quality of the prompt used for content generation can be useful or important to ensure both the fidelity of the generated content and to ensure that the context of the new content matches that of the original image, but this can be difficult to achieve. Further, current outpainting models do not consider user tastes and preferences for personalization of generated content, which would be a desirable feature. In addition, quality control of the generated content is challenging. The generated content may be totally out of context from the input image, such as an input image with people relaxing by the beach and the generated content depicting a road going through the beach.

This disclosure provides various techniques for image aspect ratio enhancement using generative AI. As described in more detail below, a diffusion model may be used for image outpainting, irrespective of the size of the original content and the available canvas. The model may be trained on one or more large training datasets, such as millions of images from diverse data sources. In addition, model optimization and compression techniques may be implemented for on-device deployment. For instance, a model optimization framework may be designed that applies multiple optimization steps sequentially to compress the model size. Large language models and prompt engineering techniques may be incorporated into prompt selection in order to design contextualized prompts for more accurate outpainting content generation. User preferences and viewership behaviors may also be incorporated into the prompt selection for personalization of the outpainting results. In some cases, a machine learning model may be trained to identify outpainted images with a bad quality of generated pixels, and a threshold may be applied to remove generated images of inferior quality.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations related to image aspect ratio enhancement using generative AI.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for image aspect ratio enhancement using generative AI. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations related to image aspect ratio enhancement using generative AI.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

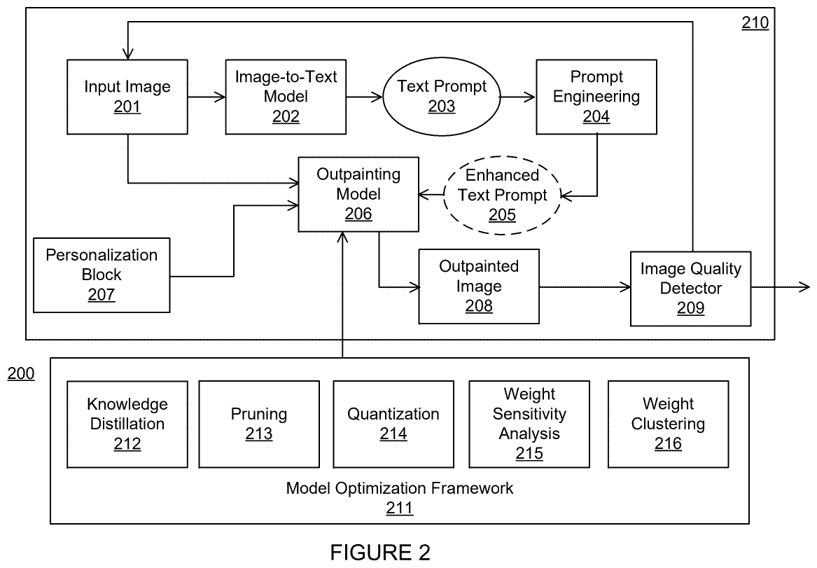

FIG. 2 illustrates an example pipeline 200 for image outpainting border regions of a display in accordance with this disclosure. For ease of explanation, the pipeline 200 of FIG. 2 is described as being implemented using one or more components of the network configuration 100 of FIG. 1 described above. For example, a portion of the pipeline 200 may be implemented using the electronic device 101 or 104 (which may represent or include an ultrawide TV, monitor, or other display), and a portion of the pipeline 200 may be implemented using one or more servers 106. However, this is merely one example, and the pipeline 200 could be implemented using any other suitable device(s) and in any other suitable system(s), such as when the pipeline 200 is implemented using a single device.

As shown in FIG. 2, the pipeline 200 operates on an input image 201 having an aspect ratio different from the aspect ratio of the display of an electronic device 101 or 104 on which the input image 201 is to be displayed. In lieu of black bars or other bars along the border regions of the display, content may be generated and image outpainting of the border regions may be performed as described below.

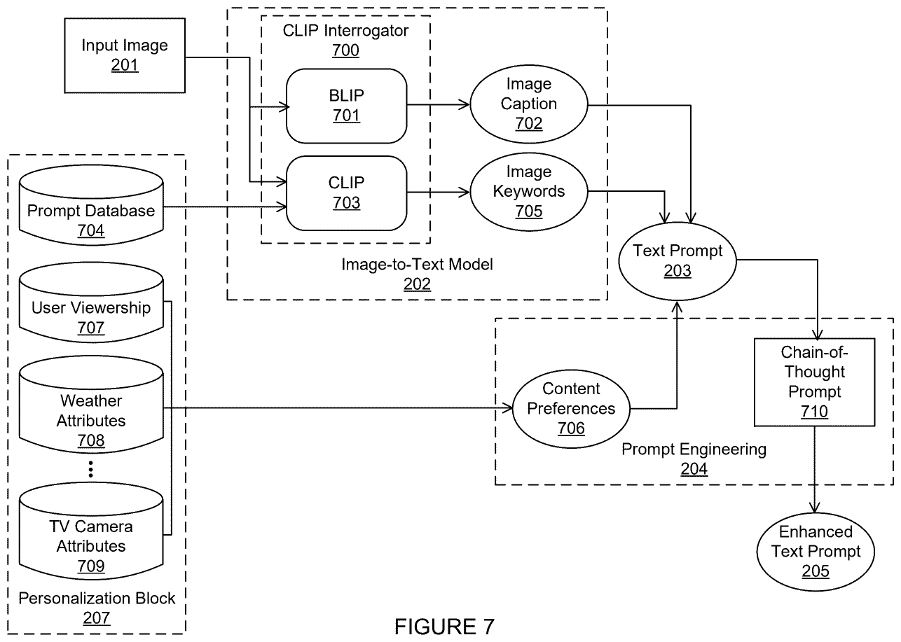

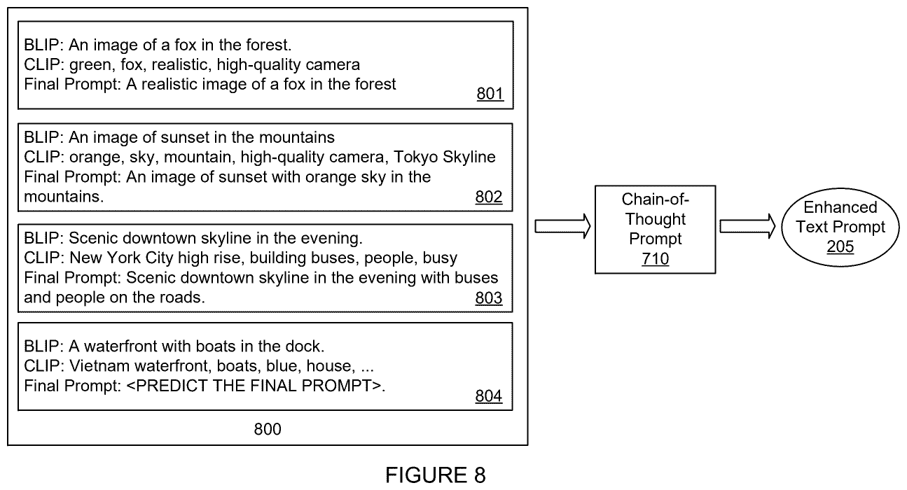

The input image 201 is provided to an image-to-text model 202 for generation of a text prompt 203. The image-to-text model 202 generates a textual description (or “caption”) and keywords for the input image 201. Parts of the textual description and keywords generated by the image-to-text model 202 may form or be used to derive portions of the text prompt 203. The text prompt 203 may be enhanced using prompt engineering 204, such as by using a few-shot inference by an LLM. In some cases, this may involve the use of FLAN-T5, which is the instruction fine-tuned version of the Text-to-Text Transfer Transformer (T5), or Falcon, which is an autoregressive decoder-only model. Example details of the image-to-text model 202 and the prompt engineering 204 are described below in connection with FIGS. 7 and 8.

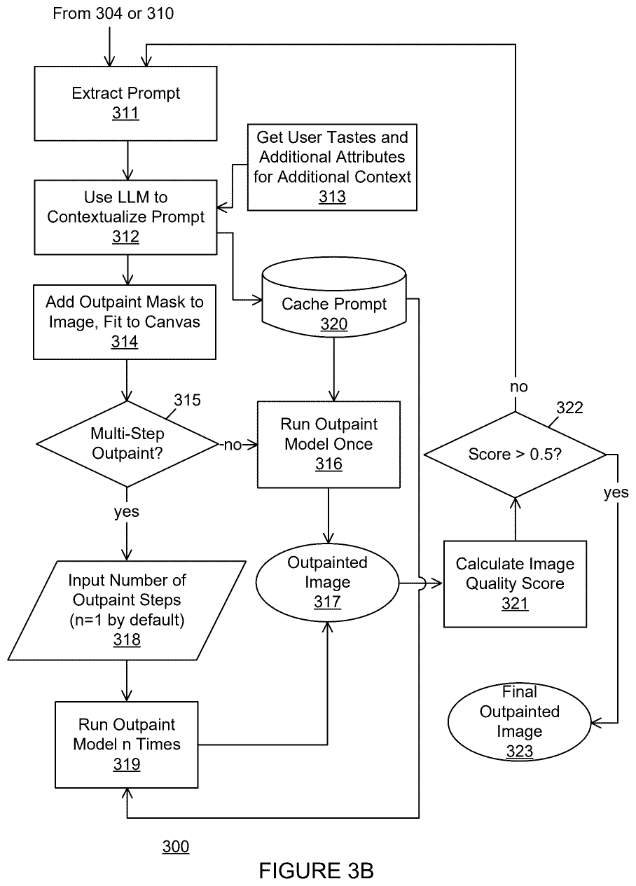

An enhanced text prompt 205 generated by the prompt engineering 204 may be provided to an outpainting model 206. The outpainting model 206 may also receive information associated with user preferences (such as viewership or weather information) from a personalization block 207. The user preferences from the personalization block 207 may also or alternatively be utilized in the prompt engineering 204 as described below. The outpainting model 206 operates on at least the enhanced text prompt 205 to generate an outpainted image 208. An example structure and example operation of the outpainting model 206 is described in further detail with FIG. 4 below.

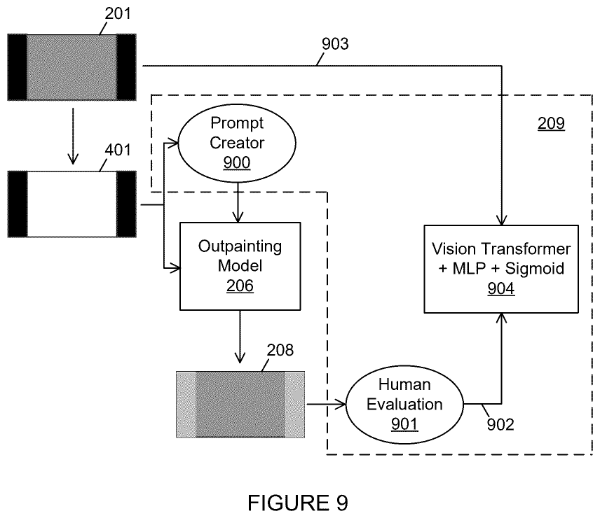

Before being presented using the display device, the outpainted image 208 generated by the outpainting model 206 may be processed by an image quality detector 209. The image quality detector 209 may determine an overall quality of the outpainted image 208, such as by employing a binary classification model to assign a quality score to the outpainted image 208. One example of this approach is described in further detail below in connection with FIG. 9. If the quality of the outpainted image 208 is below a threshold, various operations in an image outpainting portion 210 of the pipeline 200 may be rerun with the outpainted image 208 as a new input image 201 to improve the quality of the outpainted image.

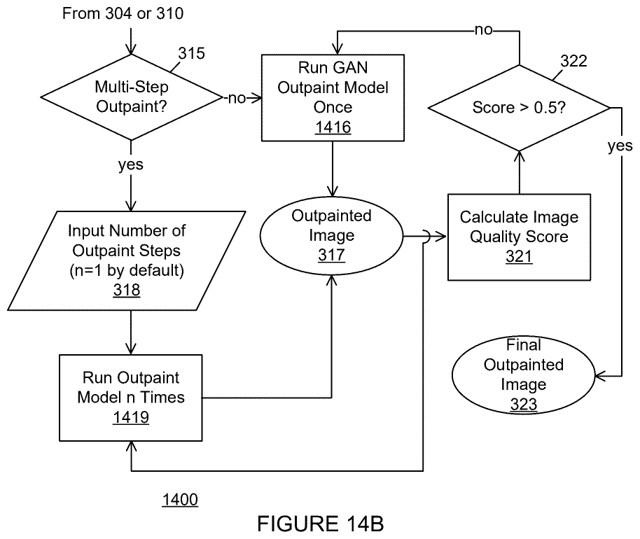

The image outpainting portion 210 may be implemented on the electronic device 101, 104 (which may be an ultrawide TV, monitor, or other display device) or on a server (such as the server 106). If implemented on an electronic device 101, 104, limited memory and/or processing power may necessitate use of a model optimization framework 211 to simplify or compress the outpainting model 206. The model optimization framework 211 includes or supports operations such as knowledge distillation 212, pruning 213, quantization 214, weight sensitivity analysis 215, and weight clustering 216. These operations are described in further detail in connection with FIGS. 16 through 21. In some embodiments, the model optimization framework 211 may be implemented on the server 106.

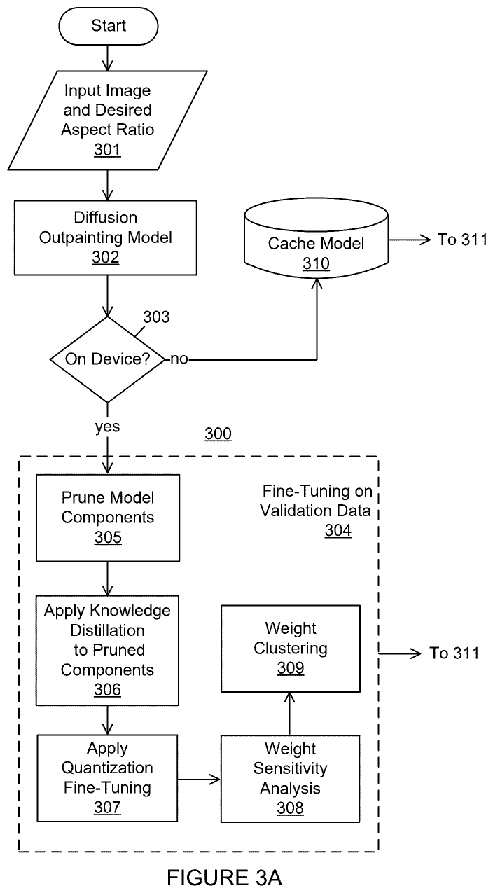

FIGS. 3A and 3B illustrate an example process 300 for implementation of the pipeline 200 of FIG. 2 in accordance with this disclosure. As shown in FIGS. 3A and 3B, the process 300 includes receiving (step 301), at the pipeline 200, the input image 201 and the desired aspect ratio for the device on which the input image 201 is to be displayed. A call (step 302) is made to the outpainting model 206 based on the received input image 201 and the desired aspect ratio. A determination (step 303) is made as to whether the outpainting model 206 is on the device on which the input image 201 is to be displayed and/or whether the outpainting model 206 is to be run on the device on which the input image 201 is to be displayed. For example, a flag may indicate that the outpainting model 206 is to be run on a cloud server, rather than on the device on which the input image 201 is to be displayed. As a particular example, constrained resources at the device on which the input image 201 is to be displayed may necessitate running the outpainting model 206 on a cloud server.

If the outpainting model 206 is to be run on the device on which the input image 201 is to be displayed, the process 300 proceeds to model fine-tuning (step 304) of the outpainting model 206 on the device, such as by using a group of functions that are analogous to those of the model optimization framework 211. The components of the diffusion outpainting model are pruned (step 305), and knowledge distillation is applied (step 306) to the pruned model components. Quantization fine-tuning (step 307) is applied, followed by weight sensitivity analysis (step 308) and weight clustering (step 309). As with the functions of corresponding model optimization framework 211, these various functions of the model fine-tuning (step 304) are described in further detail in connection with FIGS. 16 through 21 below. Upon completion of model fine-tuning, the process proceeds to prompt extraction (step 311). If the diffusion outpainting model is not executed on the device on which the input image 201 is to be displayed, the call is cached within a cache model 310 and subsequently forwarded to a diffusion outpainting model executing on an external server or other device.

From either the completion of fine-tuning (step 304) or the caching of the call in the cache model 310 for later forwarding to an external device, the process proceeds to prompt extraction (step 311) in which a text prompt is generated based on the input image 201. An initial text prompt may be produced by the image-to-text model 202, and an LLM may be used (step 312) to contextualize the initial text prompt. As part of contextualizing the text prompt in step 312, information based on user tastes and additional attributes (such as from the personalization block 207) may be considered (step 313). The contextualization of the initial text prompt may be performed using the prompt engineering 204 as described below in connection with FIGS. 7 and 8.

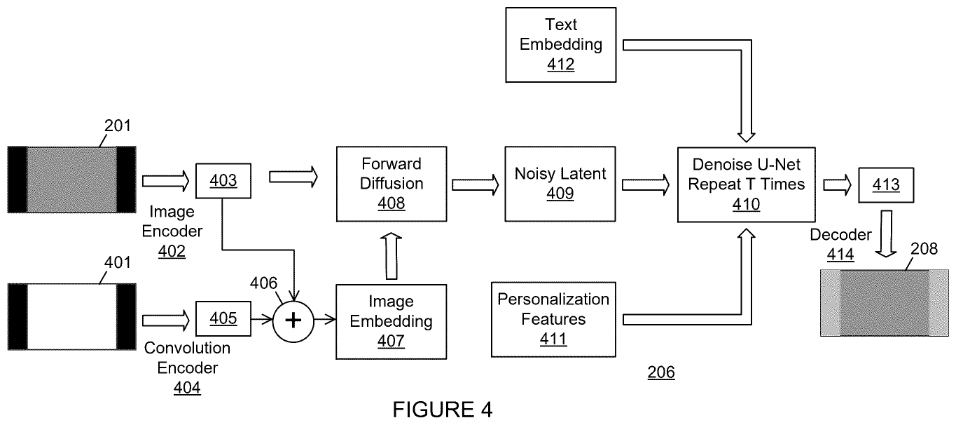

If the process 300 is executing on the device on which the input image 201 is to be displayed, an outpaint mask is added to the input image 201 as part of fitting the input image to a canvas (step 314). The canvas size can be based on the desired aspect ratio received in step 301. The masking and fitting operations allow the outpainting model 206 to handle images of different sizes, in addition to outpainting border regions of an image having a different aspect ratio from the display. Masking and fitting of the input image 201 can involve adding “blank” content adjacent to edges of the input image 201 in order to form border regions within the masked input image. A specific example of the masking and fitting operations is described below in connection with FIG. 5. Similar operations may be performed by a cloud server or other external device when the outpainting model 206 is not run on the device on which the input image 201 is to be displayed.

Following masking and fitting of the input image 201, a determination (step 315) is made as whether the call of step 302 implicates a multi-step outpaint. As noted above, the outpainting model 206 may be iteratively run multiple times to improve the quality of outpainted images. In addition, a call to the outpainting model 206 may specify that the outpainting model 206 should be run more than once on the input image 201, where the outpainted image from a first iteration is used as an input image for the second iteration, etc. For example, generation of outpainted content may be performed in steps, rather than through a single iteration of the outpainting model 206. To generate the outpainted content in steps, the outpainting model 206 may be run multiple times. Moreover, with a multi-step outpaint, each iteration need not be restricted to using a diffusion-based outpainting process. Instead, some iterations may employ interpolation while others employ diffusion, as discussed below in connection with FIG. 5.

If the call does not specify running the outpainting model multiple times, the outpaint model is run once (step 316) using the masked input image and the contextualized prompt to produce an initial outpainted image 317. If the call of step 302 implicates a multi-step outpaint, the process proceeds to inputting (step 318) a number of outpainting steps or iterations based on the call and running the outpainting model (step 319) iteratively for the number of times corresponding to a value implicated by the call. The final iteration of a multi-step outpaint produces the initial outpainted image 317.

Referring back to step 312, if the process 300 is not executing on the device on which the input image 201 is to be displayed, the contextualized prompt from step 312 is cached in the cache prompt 320 and forwarded with the cached call to the external device. The determination in step 315 of whether the call is for a multi-step outpaint may be made on the external device, and the process 300 may proceed to either step 316 or step 319 accordingly. In other cases, the outpainting model 206 may be run on the external device for as many iterations as required to generate an acceptable outpainted image.

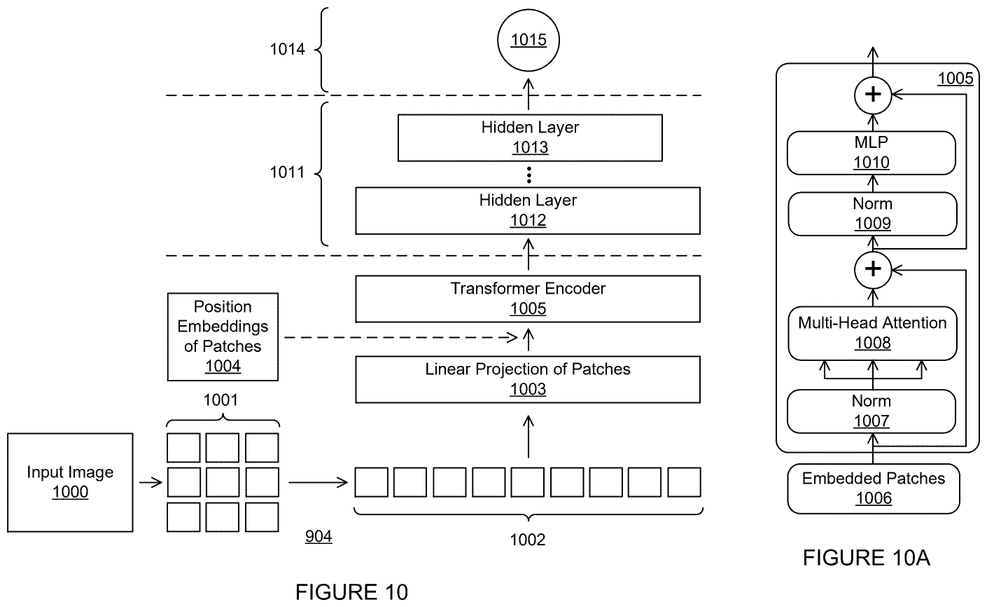

The initial outpainted image 317 is used to calculate an image score (step 321), such as by using one or more metrics determined as described below in connection with FIGS. 9 and 10. A determination (step 322) is made as to whether the image score is greater than a threshold (such as 0.5 in the example process 300). If so, the outpainted image 317 is output as the final outpainted image 323. If not, the outpainted image 317 is provided as an input image to prompt extraction (step 311), and the outpainting model is rerun.

Note that the model optimization framework 211 of the pipeline 200 here can be implemented within the step 304 for fine-tuning that is are depicted in FIG. 3A, while the image outpainting portion 210 of the pipeline 200 (using the outpainting model 206) can be implemented by the remaining steps depicted in FIG. 3A and the steps depicted in FIG. 3B. Inputs to the process 300 of FIGS. 3A and 3B can occur in steps 301 and 318, and outputs can be represented by the cache model 310, the cache prompt 320, and the final outpainted image 323.

FIG. 4 illustrates an example structure and example operation of the outpainting model 206 of FIG. 2 in accordance with this disclosure. As described above, the outpainting model 206 can be utilized in steps 316 and 319 of FIG. 3B. The input image 201 and a masked input image 401 are received by the outpainting model 206. The masked input image 401 may be generated as described in connection with step 314 of FIG. 3B and in connection with FIG. 5. The masked input image 401 signifies the portion(s) of the final outpainted image for which content needs to be generated.

The input image 201 is processed using an encoder model 402 to produce an image representation 403 in a latent space. The image encoder model 402 processes the input image 201 and extracts an image feature vector, such as by using a series of convolutional layers alternated with maximum pooling layers followed by a series of fully-connected (FC) layers. The masked input image 401 is processed using a convolution model 404 to produce a feature map 405 for the masked input image 401. The convolution model 404 may also use a series of convolutional layers alternated with maximum pooling layers followed by a series of fully-connected. The image representation 403 and the feature map 405 are concatenated 406 to produce an image embedding 407, which is a numeric representation of the input image 201 that encodes semantics of the image content.

The image representation 403 and the image embedding 407 are utilized by a forward diffusion model 408, which adds noise to the image representation 403 based on the image embedding 407 to produce a noisy latent image representation 409. The forward diffusion model 408 may be implemented in any suitable manner. In some embodiments, the forward diffusion model 408 may be implemented using a Stable Diffusion model from STABILITY AI LTD., which includes (i) a variational autoencoder (VAE) in which the VAE encoder compresses an image from a pixel space to a smaller dimensional latent space and iteratively applies Gaussian noise to the compressed latent representation during forward diffusion and (ii) a U-Net that denoises the output from the forward diffusion backwards to obtain a latent representation (where a VAE decoder converts the latent representation back into pixel space).

A denoise U-Net 410 is run a number of times (T) on the noisy latent image representation 409, personalization features 411 from the personalization block 207, and text embedding 412 based on the enhanced text prompt 205. The denoise U-Net 410 represents a convolutional neural network that can be used to reduce the amount of noise in images. In some cases, a text encoder may process the enhanced text prompt 205 for the input image 201 and produce a latent representation that is provided as context to the outpainting model 206 in order to ensure that the outpainted canvas is in line with the content of the input image 201. A guidance scale may be utilized to control the extent of the influence of the enhanced text prompt 205 on outpainting.

The denoise U-Net 410 provides fast and precise segmentation of the noisy latent image representation 409. In an encoding phase, the denoise U-Net 410 includes a series of convolution and pooling layers in which tensors get smaller and become progressively deeper, aggregating spatial information. In the decoding phase, the denoise U-Net 410 includes a matching number of upsampling and convolution layers, which transform the depth of information back to spatial information. The denoise U-Net 410 can iteratively denoise the noisy latent image representation 409 based on the personalization features 411 and the text embedding 412 in order to produce a denoised latent representation 413.

The denoised latent representation 413 is processed using a decoder model 414 to produce a predicted outpainted image 208. In some cases, the decoder model 414 may include a series of blocks each containing a masked multi-head attention submodule and a feedforward network, each with a layer normalization operation. The output of the last block can be fed through one or more linear layers and a softmax activation function to obtain the final output.

FIG. 5 illustrates an example fitting of an input image 201 to an outpainting canvas during the process 300 of FIGS. 3A and 3B in accordance with this disclosure. This fitting operation may be done during step 314 of FIG. 3B. The fitting operation can be performed so that the outpainting model 206 in FIG. 2 can handle images of different sizes. The input image 201 can have various sizes and dimensions, which means that not every image would fit in the same manner on the display of an electronic device 101 or 104. Moreover, the dimensions of the display of an electronic device 101 or 104 can vary by device type and model. Hence, an identification 501 of a type of the input image 201 and a type of the display device is made, and the input image 201 is fit to a suitable canvas for the device type.

When fitting an input image to the outpainting canvas specific to a device type, the image may be proportionally scaled in the same ratio by fixing one dimension and calculating the other dimension in proportion to the original image. For example, assume the original input image 201 received in step 301 of FIG. 3A has a width of 1920 pixels and a height of 1080 pixels. Also assume that the image is to be fit for outpainting on a canvas that has a width of 960 pixels and a height of 480 pixels. In some cases, the height may be fixed to 480 pixels, and the width may be determined as (1920/1080)×480≈850 pixels. After resizing, the image can be placed centrally on the canvas so that the outpainted regions defined by masking of the input image total (960−850)=110 pixels, meaning there is a 55 pixel by 480 pixel outpainting region on each side of the input image.

In addition, some types of images have a higher outpainting quality than others when a forward diffusion model is used. That is, for some types of image content, diffusion outpainting produces a higher quality outpainted image than an alternative approach to outpainting (such as interpolation). For other types of image content, however, diffusion outpainting produces an inferior outpainted image to the alternative approach. Diffusion operations by the outpainting model 206 may therefore not always be the best option for performing outpainting.

Accordingly, in connection with determining the input image type in terms of pixel dimensions for purposes of fitting the input image 201 to the canvas, a machine learning (ML)-based approach to image type identification 501 may optionally be used to identify the content of the input image 201 in order to select an outpainting strategy 502 based on the result. The content of the input image 201 may be of a type for which a bicubic interpolation approach is likely to produce better quality outpainting than the diffusion model. In addition to diffusion and bicubic interpolation as alternatives, a combination of interpolation and the diffusion model may be used to perform outpainting, such as in different iterations of running the outpainting model 206. Moreover, different segments or patches of an input image 201 may have different types of image contents, such as when one edge is a boundary for a first type of image content and the opposite edge is a boundary for a second type of image content. In any of those cases, the image type identification 501 may optionally be employed to determine a type of the image content within the input image 201 (or regions therein) for selection of an outpainting strategy 502. In some cases, the image type identification model 501 may be a deep neural network trained based on image quality scores calculated in step 321 (described in greater detail below in connection with FIG. 9).

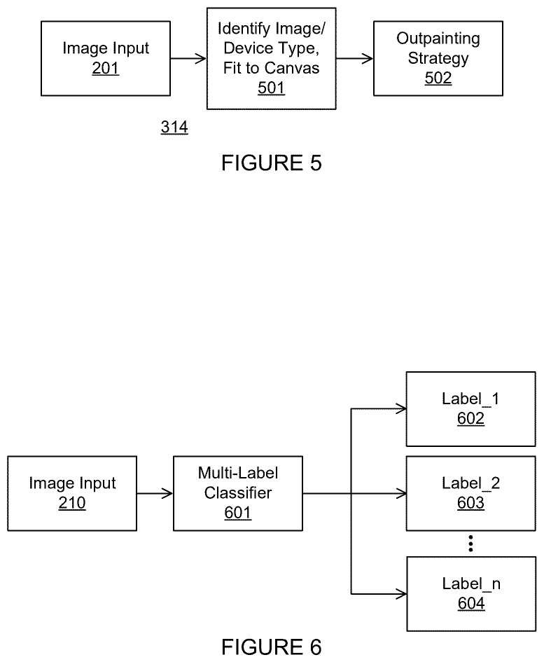

FIG. 6 illustrates example operation of the image-to-text model 202 of FIG. 2 used for prompt extraction during the process 300 of FIGS. 3A and 3B in accordance with this disclosure. As described above, the image-to-text model 202 may be used during step 311 in FIG. 3B for selection of a prompt for an image. A diffusion model may use or require accurate prompts for high-quality image outpainting generation. To simplify the workflow, a framework to optimize the prompt selection process may leverage an ML model to select the prompt. In FIG. 6, some number n (such as 100) of static prompts may be used by a multi-label classifier model 601 to make a choice for the best prompt(s) from the preselected subset of possible prompts. In some cases, the multi-label classifier model 601 here may be designed as a variant of a backpropagation for multilabel learning (BP-MLL) neural network that performs feature extraction for a fully-connected network. Each prompt can be set as a label, such as label_1 602, label_2 603, . . . , label_n 604. A mapping between prompts and labels can be created as follows.

$$\begin{matrix}label\_ 1 = prompt\_ 1 \\ label\_ 2 = prompt\_ 2 \\ ⋮ \\ label\_n = prompt\_n\end{matrix}$$

The multi-label classifier model 601 may be trained to predict one or more of these labels for an input image 201. At inference time, the multi-label classifier model 601 predicts a probability for each label for the given input image 201. The prompts corresponding to labels with a probability above a specified threshold can be concatenated together for the final prompt. For example, if a threshold of 0.5 is set and label_1 and label_5 (not shown in FIG. 6) respectively have a predicted probability of 0.7 and 0.8, the final prompt may be defined as follows.

$$final\_prompt = prompt\_ 1 + prompt\_ 5$$

The final_prompt may be used as the text prompt 203 that is input to the prompt engineering 204, such as to a chain-of-thought prompt model shown in FIG. 7. Limiting the prompts from which the multi-label classifier model 601 can make selections may facilitate on-device use of the outpainting model 206. For example, an ML model with an integrator to select prompts for an input image could be challenging to implement for on-device performance.

FIG. 7 illustrates an example image-to-text model 202, an example prompt engineering 204, and an example personalization block 207 of FIG. 2 in accordance with this disclosure. In this example, the image-to-text model 202 creates prompts using one or more LLMs. For example, in the image-to-text model 202, the input image 201 is received at a bootstrapping language image pretraining (BLIP) model 701, which is a decoder-based model that produces an image caption 702. The input image 201 is also received at a contrastive language image pretraining (CLIP) model 703, which is an encoder-based model that produces image keywords 705 and attempts to minimize the distance between image/text pairs in the latent space. In some cases, the CLIP model 703 may operate to minimize the distance between the input image 201 and image keywords 705 corresponding to prompts from a prompt database 704, such as static prompts of the type described above. The image caption 702 and the image keywords 705 are used as part of the text prompt 203.

At least part of the text prompt 203 is prompt-enhancement based on one or more personalization features received by the prompt engineering 204 as content preferences 706 derived from a user viewership database 707, a weather attributes database 708, TV camera attributes 709, or other source(s). The prompt engineering 204 also includes or uses a chain-of-thought prompt model 710 operating on the text prompt 203 to generate the final enhanced text prompt 205. In some cases, good prompts for training images are manually created as examples and fed into an LLM for the chain-of-thought prompt model 710 in order to generate more accurate prompts, such as based on few-shot inference natural language processing (NLP), to automatically identify edge cases.

FIG. 8 illustrates an example training of a chain-of-thought prompt model 710 in accordance with this disclosure. As shown in FIG. 8, a training and test corpus 800 includes three example training queries and associated final prompts 801-803 for training the chain-of-thought prompt model 710 using associated training images. As described above, the chain-of-thought prompt model 710 may represent a few-shot inference LLM. The training and test corpus 800 also includes an example test query 804 for generation of a final prompt by the trained chain-of-thought prompt model 710. Each of the training queries and associated final prompts 801-803 includes an image caption 702 from the BLIP model 701 and image keywords 705 from the CLIP model 703, together with final prompts (which could be manually created) based on the image caption, the image keywords, and the associated training image.

Some predictions from the CLIP model 703 may not be very useful since the model could only be trained to predict words. Terms like “New York City,” “Vietnam,” etc. are not useful since the terms are very specific to a location, unlike input images to which such location-specific information does not apply. The manually-created or other predictions for the associated final prompts massage the outputs from the BLIP model 701 with indicators from the CLIP model 703 to create the final prompt. The training queries and associated final prompts 801-803 and the associated manually-created or other final prompts are provided as examples to the chain-of-thought prompt model 710. The test query 804 and the associated image can be input to the chain-of-thought prompt model 710 after training for prediction of a final prompt, which is represented as <PREDICT THE FINAL PROMPT> in the example shown. The enhanced text prompt 205 output by the chain-of-thought prompt model 710 may be “A waterfront with boats on the dock and a house in the background.”

FIG. 9 illustrates an example image quality detector 209 of FIG. 2 used to calculate an image quality score during the process 300 of FIGS. 3A and 3B in accordance with this disclosure. As described above, the image quality detector 209 may be used during step 321 in FIG. 3B to calculate an image quality score. The image quality detector 209 can include a framework to score images as good or bad in terms of generated content. For example, the image quality detector 209 may use a binary classifier trained to distinguish good outpainting results from bad outpainting results. In the image quality detector 209, the input image 201 and the masked input image 401 can be employed together with the diffusion outpainting model 206.

As shown in FIG. 9, the masked input image 401 is provided to a prompt creator 900 in which the prompt for the diffusion outpainting model 206 based on the masked input image 401 is manually or otherwise created and is intentionally bad. The resulting outpainted image 208 is subject to human evaluation 901. During the human evaluation 901, the outpainted image 208 is labeled with a binary value y=[0, 1]. The human evaluation 901 may be used, rather than simply labeling the outpainted image 208 as bad (assigned a label y=0), because the outpainting model 206 can sometimes hallucinate and give good results (which would be assigned a label y=1) even with bad prompts. The label 902 from the human evaluation 901 and a label 903 for the input image 201 are input to a vision transformer, multi-layer perceptron (MLP), and sigmoid function 904 described in further detail below. The intentionally-bad prompt from the prompt creator 900, the input image 201, the outpainted image 208, and the associated labels 902-903 are used to train the vision transformer, MLP, and sigmoid function 904.

FIGS. 10 and 10A illustrate an example vision transformer, MLP, and sigmoid function 904 of FIG. 9 in accordance with this disclosure. The vision transformer, MLP, and sigmoid function 904 in FIG. 10 operates on an input image 1000, which may be either the input image 201 or the outpainted image 208. The input image 1000 is segmented into image patches 1001, which can be rearranged into a linear stacking 1002 of the image patches that is used to create a linear projection 1003 of the image patches (such as by using a convolution operation). The linear projection 1003 and the position embeddings 1004 of the image patches are input into a vision transformer encoder 1005.

As shown in FIG. 10A, the transformer encoder 1005 receives embedded patches 1006 corresponding to the linear projection 1003 and the position embeddings 1004. The transformer encoder 1005 includes a first normalization layer 1007, a multi-head self-attention layer 1008, a second normalization layer 1009, and a multi-layer perceptron (MLP) 1010. The embedded patches 1006 are normalized by the first normalization layer 1007. The normalized output from the first normalization layer 1007 is received by the multi-head self-attention layer 1008, which provides an attention mechanism that is used multiple times in parallel to process the normalized embedded patches. The resulting outputs from the attention mechanism are concatenated and possibly transformed linearly. This effectively allows the multi-head self-attention layer 1008 to provide attention to different parts of the normalized embedded patches in different ways.

Outputs from the multi-head self-attention layer 1008 and the original inputs to the multi-head self-attention layer 1008 are combined (such as via addition), and the results are normalized by the second normalization layer 1009. Outputs from the second normalization layer 1009 are provided to the MLP 1010 in which weights are applied to the normalized results associated with all tokens representing outputs from the combination of the outputs from and the original inputs to the multi-head self-attention layer 1008. Outputs from the MLP 1010 and the original inputs to the MLP 1010 are combined (such as via addition), and the results are output by the transformer encoder 1005. The outputs from the transformer encoder 1005 represent an encoded version of the original embedded patches 1006.

Referring back to FIG. 10, the outputs from the transformer encoder 1005 are provided to a fully-connected network 1011 of hidden layers 1012 and 1013. While two hidden layers 1012 and 1013 are shown here, the fully-connected network 1011 may include any other suitable number of hidden layers. Within the fully-connected network 1011, each input of any of the hidden layers 1012 and 1013 is connected to all of the outputs of the previous layer, with each input of the respective hidden layer connected by weights (represented in a weights matrix) to every output of that hidden layer. The outputs from the fully-connected network 1011 are provided to a decision layer 1014, which in this example implements a sigmoid function 1015. Using the sigmoid function 1015, the final output from the vision transformer, MLP, and sigmoid function 904 is compared to a threshold value (such as 0.5). If the value of the final output is greater than that threshold value, the input image 1000 is considered a good image. If the input image 1000 is the outpainted image 317, the outpainted image may be provided as the final outpainted image 323 for display on the ultrawide TV, monitor, or other display device.

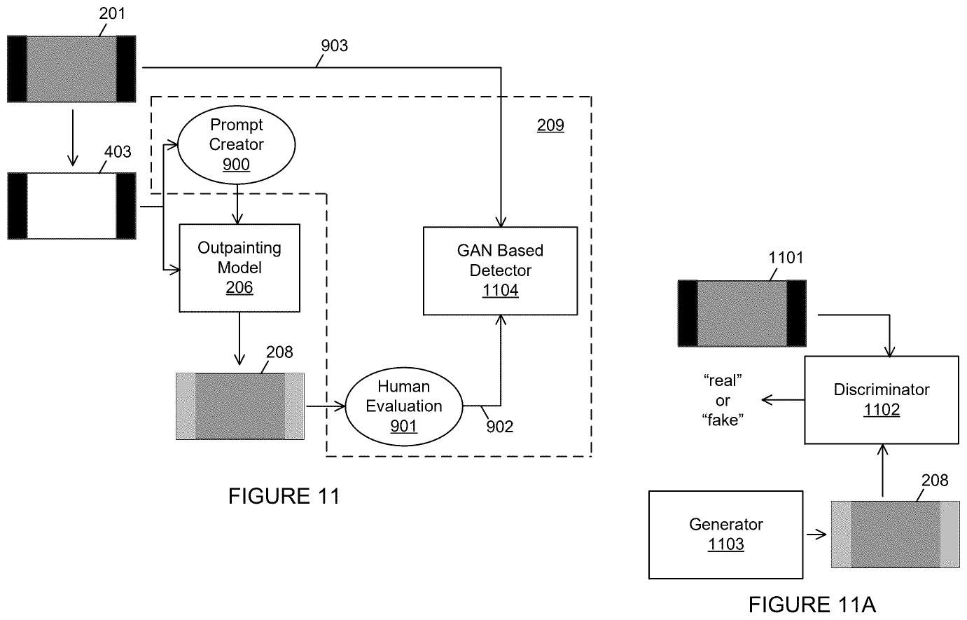

FIGS. 11 and 11A illustrate another example image quality detector 209 of FIG. 2 used to calculate an image quality score during the process 300 of FIGS. 3A and 3B in accordance with this disclosure. As shown in FIG. 11, a generative adversarial network (GAN)-based detector 1104 is used in place of the vision transformer, MLP, and sigmoid function 904 of FIGS. 9 and 10. All other functions and signal flows remain the same.

FIG. 11A illustrates example operation of the GAN-based detector 1104 in FIG. 11. One goal of the GAN-based detector 1104 can be to force the outpainting model 206 to generate an outpainted image 208 that cannot be distinguished from a “real” image 1101. A discriminator network 1102 outputs a prediction (“real” or “fake”) for each outpainted image 208. A generator network 1103 generates candidates for the outpainted image 208, while the discriminator network 1102 evaluates those candidates. During training from a known dataset, one training objective for the generator network 1103 (which may be an implementation of the outpainting model 206) can be to “fool” the discriminator network 1102 by producing outpainted image candidates that the discriminator network 1102 predicts are not synthesized. The “real” image 1101 may be the original unmasked input image 201.

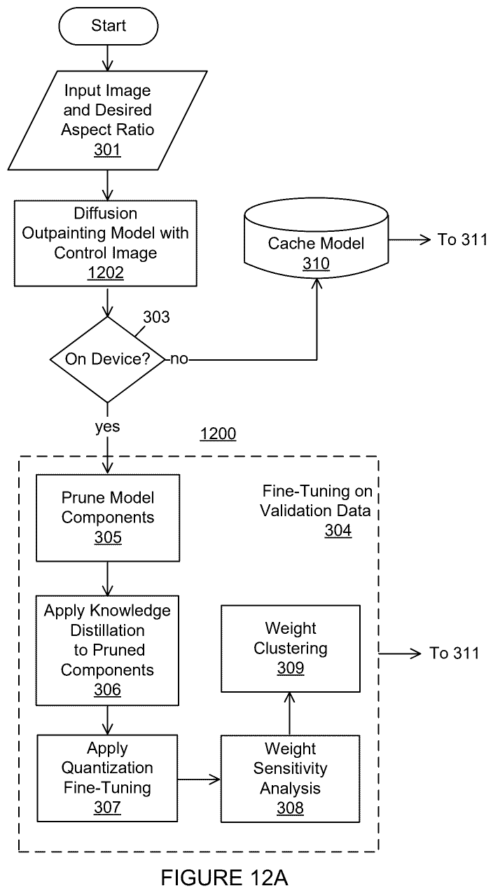

FIGS. 12A and 12B illustrate another example process 1200 for implementation of the pipeline 200 of FIG. 2 in accordance with this disclosure. The process 1200 differs from the process 300 in FIGS. 3A and 3B by (i) inclusion of a control image with the call (step 1202) made to the diffusion outpainting model in FIG. 12A and (ii) use (step 1201) of a canny edge detector to complete edges of the input image 201 in FIG. 12B. All other process steps, flow paths, and inputs/outputs remain the same.

The control image passed to the diffusion outpainting model in step 1202 may be based on the use of an edge detector, a pose estimator, or the like being applied to the input image 201. The control image is passed together with the masked input image 401 and the prompt to the diffusion outpainting model in order to provide additional information about what image content needs to be generated for the border region(s) of the display. For example, additional information regarding the edges of the input image 201 could allow the outpainting model 206 to better extrapolate image content for the border regions being outpainted. In some embodiments, the canny edge detector used in step 1201 may be used to generate the control image for the diffusion outpainting model 206.

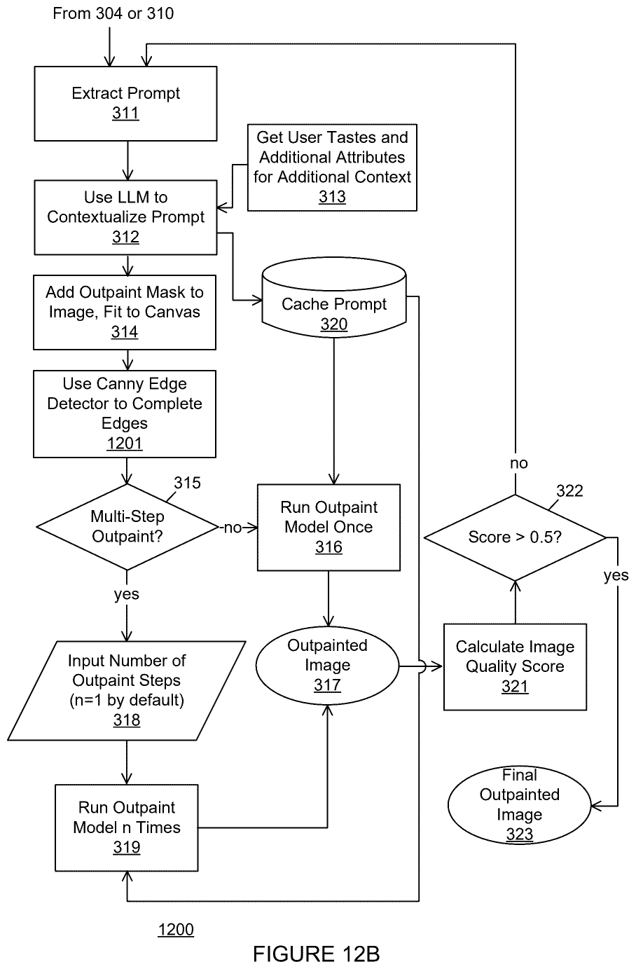

FIG. 13 illustrates an example structure and example operation of the outpainting model 206 used in the process 1200 of FIGS. 12A and 12B in accordance with this disclosure. The structure and operation of the outpainting model 206 shown in FIG. 13 is similar to the structure and operation of the outpainting model 206 shown in FIG. 4. For simplicity, the description of those portions that are unchanged will not be repeated here.

The implementation of the outpainting model 206 in FIG. 13 utilizes a ControlNet structure to control the diffusion model by adding extra conditions and copying weights of neural network blocks into (i) a “locked” copy that preserves the model and (ii) a “trainable” copy that learns the conditions and is bracketed by zero convolutions. The ControlNet controls the quality of the contents generated by the diffusion outpainting model 206. In the implementation of FIG. 13, the ControlNet structure uses an additional input, namely a control image 1301. The control image 1301 is an abstract representation of the output image desired. The control image 1301 can be represented in any suitable manner, such as through a depth map, a canny edge map, segmentation maps, etc. The original input image 201 can be used to create the control image 1301. For the masked regions within the masked input image 401, the control image 1301 is extrapolated to span the image canvas in the new aspect ratio.

The control image 1301 is processed using a convolution model 1304 to produce a control map 1305 for the control image 1301. The control map 1305 is concatenated together with the image representation 403 and the feature map 405. As noted, the control image 1301 can be a depth map of an image, an edge map generated by a canny edge detector, etc. For the masked region(s) of the masked input image 401, a separate model may be used to predict the contents of the control image 1301, which are passed to the outpainting model 206.

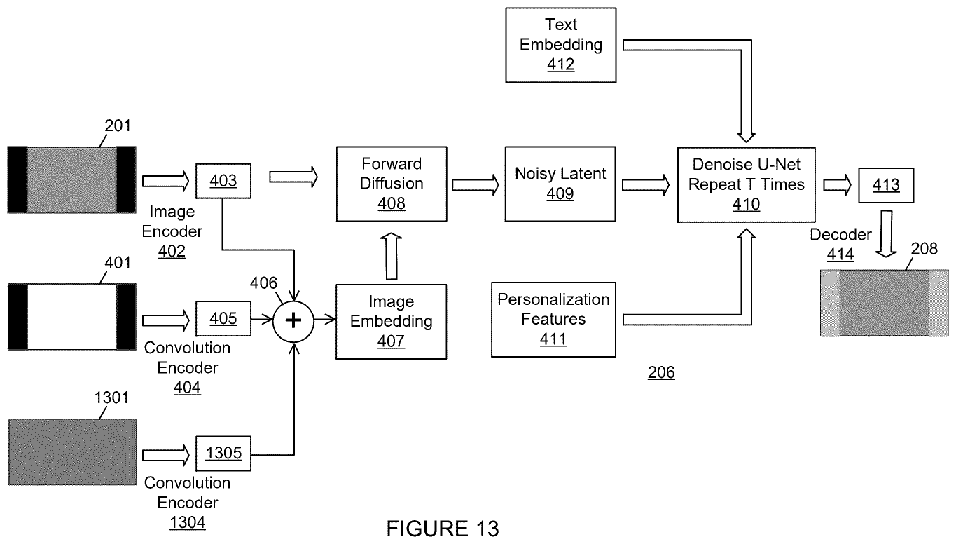

FIGS. 14A and 14B illustrate yet another example process 1400 for implementation of the pipeline 200 of FIG. 2 in accordance with this disclosure. The process 1400 differs from the process 300 in FIGS. 3A and 3B by use of a call (step 1402 in FIG. 14A) to a GAN-based outpainting model rather than to a diffusion-based outpainting model. In addition, steps 311-314 and storage in the cache prompt 320 of FIG. 3B may not be necessary for the process 1400, and a GAN-based outpainting model can be run in steps 1416 and 1419 of FIG. 14B (rather than a diffusion based outpainting model). All other process steps, flow paths, and inputs/outputs remain the same.

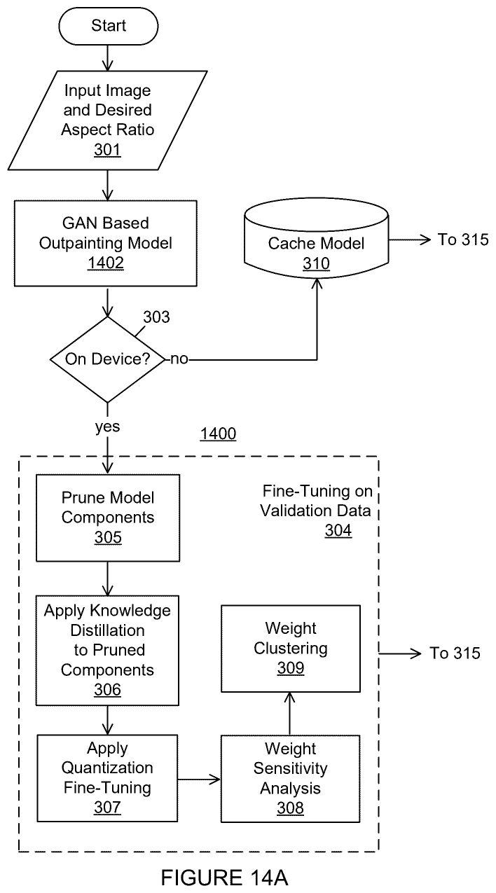

FIG. 15 illustrates an example structure and example operation of the outpainting model 206 used in the process 1400 of FIGS. 14A and 14B in accordance with this disclosure. As noted above, the outpainting model 206 may be utilized in steps 1416 and 1419 of FIG. 14B. Since the size of a diffusion-based outpainting model may be extremely large, a GAN-based outpainting model 1506 may be used since it can be much simpler and therefore more readily implemented on a display device. The input image 201 is received by a generator network 1501, which produces a generated image 1502 having outpainted regions adjacent to the content of the original input image 201. In some cases, the generator network 1501 may be implemented as an encoder-decoder network, where the encoder generates a representation of the original input image 201 and the decoder produces the generated image 1502 based on that representation. An image refinement 1503 is performed on the generated image 1502 using the masked image 401 as a reference. The refined image from the image refinement 1503 is supplied to a discriminator network 1504, which verifies that the outpainted regions of the refined image are consistent with the content of the original input image 201. Note that the discriminator network 1504 may not be needed when generating new images, only the generator network 1501. However, the discriminator network 1504 ensures acceptable quality of the outpainted image.

Referring back to FIG. 2, the model optimization framework 211 sequentially applies the knowledge distillation 212, pruning 213, quantization 214, weight sensitivity analysis 215, and weight clustering 216. The architecture of a stable diffusion model is typically very complex. To reduce the architectural complexity while substantially preserving the output, simplification of the architecture of the outpainting model 206 can be performed, such as by using a student teacher framework for the knowledge distillation 212 and pruning 213 in FIG. 2 and for the steps of pruning of model components (step 305) and applying knowledge distillation to the pruned components (step 306) in FIG. 3A. In model simplification, knowledge distillation and pruning can be performed independently for each sub-model, including specifically the encoder model 402, the convolution model 404, each sub-model of the forward diffusion model 408, the denoise U-Net 410, and the decoder model 414.

FIG. 16 illustrates an example student teacher framework 1600 in accordance with this disclosure. The teacher model represents the more complex original version of the model, which can be implemented by various hidden layers 1601 that produce teacher model outputs 1602. The student model represents a much simpler version of the model, which can be implemented by various hidden layers 1603 designed to produce student model outputs 1604. Ideally, the student model outputs 1604 are substantially the same as the teacher model outputs 1602. In some cases, the output (right-most) layer or layers among the hidden layers 1603 of the student model may be kept the same as the output (right-most) layer or layers among the hidden layers 1601 of the teacher model. In other words, only the hidden layers 1603 of the student model other than the output layer(s) may be simplified.

In this example, predictions regarding the input image 201 are made using the teacher model for each component (such as encoder, U-Net, decoder) of the outpainting model 206. The student model is designed for the corresponding model component to optimize prediction of the teacher model outputs 1602, thereby producing substantially the same outputs with a less complex model. The student model can be trained using the differences in the outputs with the teacher model. For example, the differences between the teacher model outputs 1602 and the student model outputs 1604 can be incorporated into a loss function of the student model, and the student model weights can be updated, such as by using backpropagation 1605. In some cases, backpropagation 1605 here may not consider a ground truth due to both the lack of actual labels and the potentially-hallucinating nature of the outpainting model 206. As depicted in FIG. 16, the number of hidden layers 1603 for the student model is reduced relative to the number of hidden layers 1601 of the teacher model, effectively pruning the model.

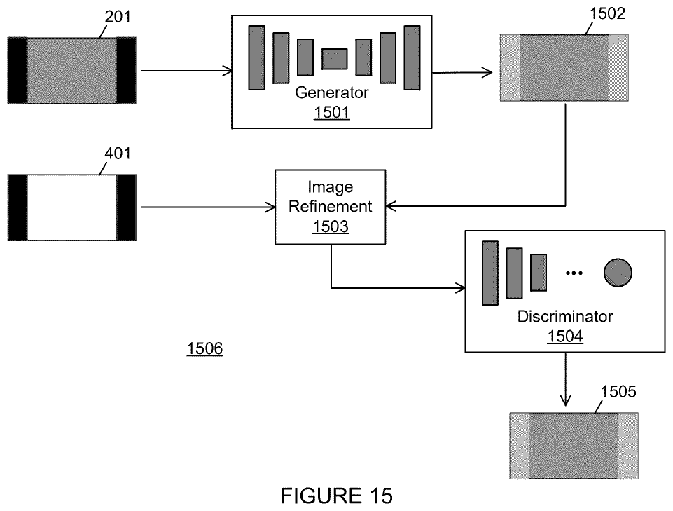

FIG. 17 illustrates a specific example implementation 1700 of the student teacher framework 1600 of FIG. 16 in accordance with this disclosure. As described above, the implementation 1700 of the student teacher framework 1600 may be used in the knowledge distillation 212 and pruning 213 or during pruning of model components (step 305) and applying knowledge distillation to the pruned components (step 306). The implementation 1700 here receives and processes a noisy image 1701.

The implementation 1700 here includes a “customized” student model 1702, which represents a student model architecture selected by a designer and configured to produce a desired output, namely an outpainted image in this example. The customized student model 1702 and its associated inputs and outputs are received by a neural architecture search (NAS) model 1703. The NAS model 1703 searches, among a space of allowable artificial neural network architectures, to find the optimal student model architecture for implementing the prediction needed for the type of inputs received. That architecture is utilized to implement two copies of the same student model: a first student model 1704 and a second student model 1705.

The second student model 1705 applies the denoising process at timestep t2 within the backpropagation, while the first student model 1704 applies the denoising process at timestep t1<t2 and therefore produces a less noisy output. The output of the second student model 1705 is concatenated with the noise from the noisy image 1701, and the result is provided as an input to the teacher model 1706. The weights of the teacher model 1706 are frozen, and the teacher model 1706 generates a prediction based on the concatenated result of the output of the second student model 1705 and the noisy image 1701 noise. The prediction by the teacher model 1706 is concatenated with the concatenated result of the output of the second student model 1705 and the noise of the noisy image 1701. That concatenated information is provided to a proxy prediction model 1707, together with the output of the first student model 1704, to minimize a loss 1708 of the proxy prediction by the proxy prediction model 1707. The output of the first student model 1704 (at a lower timestep) combined with the output of the second student model 1705 (at a higher timestep) and the prediction by the teacher model 1706 are used to minimize a loss by the first student model 1704 relative to the teacher model 1706.

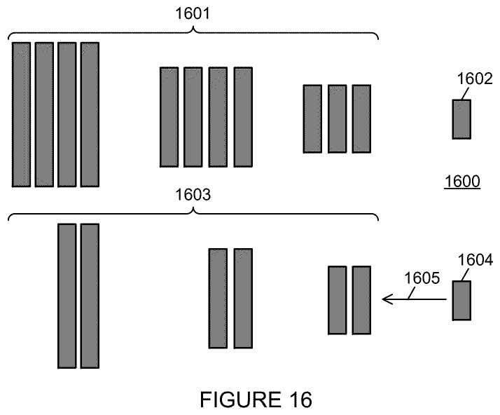

FIG. 18 illustrates an example quantization 214 from the model optimization framework 211 of FIG. 2 and an example of applying quantization fine-tuning during the process 300 of FIGS. 3A and 3B in accordance with this disclosure. For example, the quantization 214 can be used for quantization fine-tuning during step 307 in FIG. 3A. Quantization is the process of discretizing inputs from a representation with more information to a representation with less information, such as by converting 32-bit floating point representations X^{FP32} into 8-bit integer values X^{Int8}. In some embodiments, the quantization equations for such conversion may be expressed as follows.

$${X}^{I n t 8} = round ( \frac{127}{abs max ( {X}^{F P 32} )} {X}^{F P 32} ) = round ( {c}^{F P 32} \cdot {X}^{F P 32} )$$

Here, c is the quantization scale, round( ) is a rounding function, and absmax( ) returns the absolute maximum. The maximum value in the higher precision representation is mapped to the maximum value for the lower precision scale, and all values are scaled accordingly.

In some embodiments, quantization may be used only to discretize student model weights from previous steps. In order to fine-tune the student model, additional weight matrices that are a low-rank decomposition of the original weight matrices can be introduced. The quantized weights of the student model can be frozen during fine-tuning, and only the rank decomposition matrices may be optimized. In the example of FIG. 18, a quantized weight matrix W having dimensions h×b is frozen. Decomposition (or approximating) matrices L1 and L2 having dimensions respectively of h×r and r×b are trainable, where r is the rank of the approximating matrices. For a given input X, the output may be calculated as XW+s(X. L1. L2). In particular embodiments, this approach may primarily be used on the denoising U-Net 410 of the outpainting model 206, which can be the most parameter-heavy component of the architecture and applies cross-attention along with skip connections.

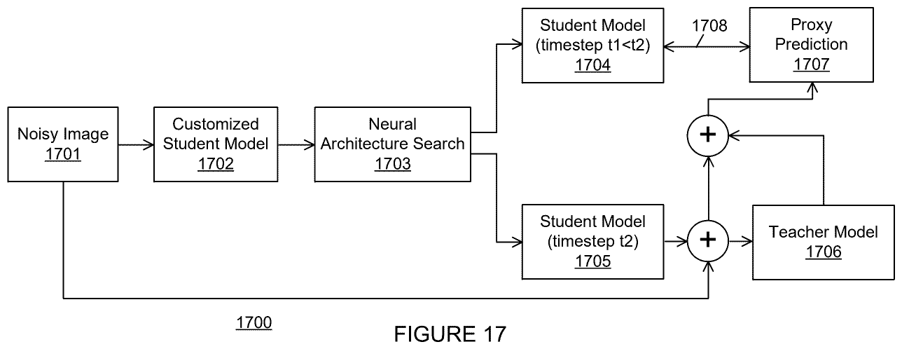

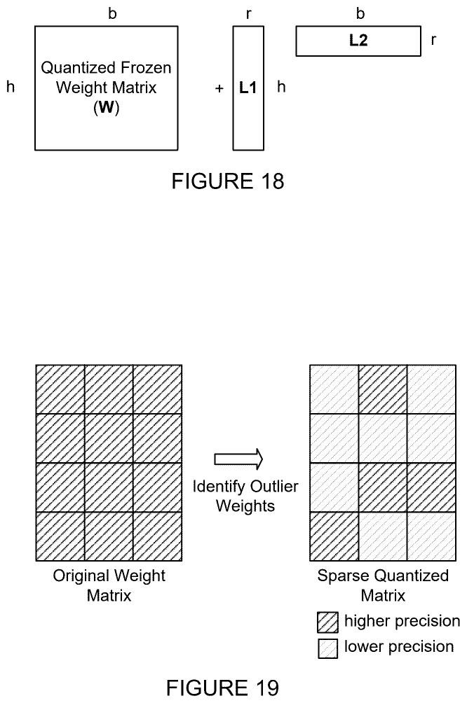

FIGS. 19 and 20 illustrate an example weight sensitivity analysis 215 by the model optimization framework 211 of FIG. 2 and an example weight sensitivity analysis during the process 300 of FIGS. 3A and 3B in accordance with this disclosure. For example, the weight sensitivity analysis 215 can be used during step 308 in FIG. 3A. For autoencoder portions of the outpainting model 206, a post-training quantization technique called sparse quantized representation of model weights may be used. Some model weights disproportionately influence the model outputs, so saving those weights in a higher precision representation while quantizing the remaining weights may be worthwhile.

An original weight matrix and a corresponding sparse quantized matrix are depicted in FIG. 19, where outlier weights are stored in a higher-precision representation while the remaining weights are quantized to a lower precision. An example identification of the outlier weights is illustrated in FIG. 20. Here, the outlier weights may be identified using a calibration dataset to go through the original model and the compressed model after quantization. The calibration dataset may be the original weights before sparse quantization. In the process 2000 of FIG. 20, for each column (“col”) in the original weight matrix 2001, the weights in the column are quantized (step 2002). The L2 norm of the difference between the original matrix 2001 and the matrix with the subject column quantized is calculated (step 2003). If the difference is greater than a specified threshold T, that column of weights may potentially contain outliers and remains stored in a higher precision (such as 32 bits) rather than being quantized (such as to a 4-bit representation). This process can be iterative and be performed layer by layer. Once a column is identified as potentially important to the prediction using the weight matrix, each weight within the column may be individually quantized, and the importance of the respective column element is determined individually based on calculation of L2 norm with and without that column element quantized (step 2005). Once all columns and column elements have been checked for outliers, the quantized weights for non-outliers are stored in the sparse quantized weight matrix 2006.

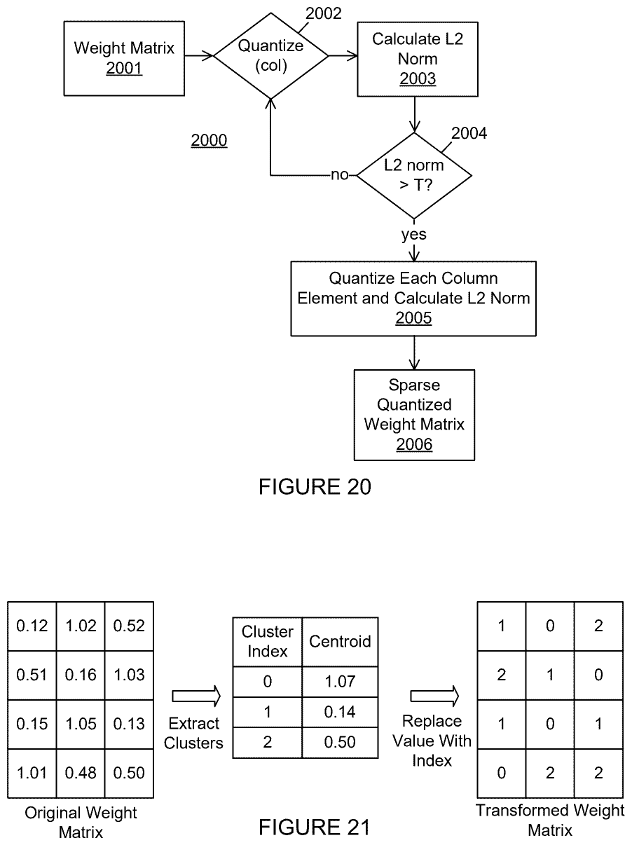

FIG. 21 illustrates an example weight clustering 216 by the model optimization framework 211 of FIG. 2 and an example weight clustering during the process of FIGS. 3A and 3B in accordance with this disclosure. For example, the weight clustering 216 can be used during step 309 in FIG. 3A. In order to optimize the memory usage of the outpainting model 206, a clustering algorithm may be applied to model weights. Once cluster centroids are identified, each neuron can be represented by an integer corresponding to the cluster index so that only the cluster centroids are stored at a high precision and the individual weights are represented as integers. In some embodiments, the clustering can be performed at every level of the network.

In the example of FIG. 21, the weights within the original weight matrix having a cluster centroid value of 1.07 (such as the weight values 1.01, 1.02, 1.03, and 1.05) are all represented by a cluster index of 0 in the transformed weight matrix. The weights within the original weight matrix having a cluster centroid value of 0.14 (such as the weight values 0.12, 0.13, 0.15, and 0.16) are all represented by the cluster index of 1 in the transformed weight matrix. The weights within the original weight matrix having a cluster centroid value of 0.50 (such as the weight values 0.48, 0.50, 0.51. and 0.52) are all represented by the cluster index of 1 in the transformed weight matrix.

Although FIGS. 2 through 21 illustrate examples of pipelines for image outpainting border regions of a display and related details, various changes may be made to FIGS. 2 through 21. For example, various components and functions in any of FIGS. 2 through 21 may be combined, further subdivided, replicated, rearranged, or omitted according to particular needs. Also, one or more additional components and functions may be included in any of FIGS. 2 through 21 if needed or desired. In addition, while each of the various processes are described above as involving a specific sequence of operations, various operations described with respect to FIGS. 2 through 21 could overlap, occur in parallel, occur in a different order, or occur any number of times (including zero times).

The described techniques for image aspect ratio enhancement using generative AI may find use in a number of applications or use cases. The following provides specific examples of applications or use cases that can involve the use of image aspect ratio enhancement using generative AI. Note, however, that these applications or use cases are for illustration and explanation only. The techniques for image aspect ratio enhancement using generative AI described above may be used in any other suitable manner.

As one example, the additional real estate on wide screens for higher aspect ratio content provides an opportunity to target users with relevant product advertisements. Where user viewership behavior is available, that information can be leveraged to understand the preferences for each user in terms of both content preference and display ads that are in line with those preferences.

Outpainting can also be used to enhance photo casting. For example, the enhanced full screen image viewing experience on wide screens improves photo casting from mobile phones onto ultrawide TVs or other display devices. The majority of photos acquired with smartphone cameras have a lower aspect ratio, such as 4:3. To enhance the content by further extending the image horizon, the photos can be cast onto an ultrawide TV or other display device using the outpainting technology described above to generate new content for any desired aspect ratio. In some cases, the outpainted photos can be saved on the device and displayed as a slide show.

Outpainting may further be employed for personalization. For example, the prompt used to create an outpainted image can be personalized through additional information, such as the weather, TV viewership, mood of the user, etc. Outpainted images that are very specific to user tastes and preferences can therefore be generated.

Outpainting may also be utilized for aspect ratio adaptation for ultrawide monitors. The aspect ratio of ultrawide monitors is often much larger than the content that is created, typically in 4:3 and 16:9 aspect ratios. To support the growing ultrawide monitor market, outpainting may be applied to the content with a seamless viewing experience. Note that aspect ratio enhancement can be applied not just on ultrawide TVs and monitors but to any screen that supports higher aspect ratios, such as gaming monitors or smartphones.

In addition, outpainting can be exploited to create new content. For example, the image level outpainting technology described above can be used to create new content by successively applying outpainting to generate new images with additional content and stitching together the frames to create a temporally-consistent video.

Despite exponential growth for content creation, two main bottlenecks can inhibit the integration of generative AI in products. One bottleneck is model size—the size of generative AI models is huge, making it hard to run such models on end use devices. The present disclosure uses multiple model compression steps and optimizations to reduce model size with acceptable output quality. Another bottleneck is the potentially-hallucinating nature of generative AI outputs-precise control over the quality of generated content is difficult. The present disclosure addresses that issue, such as by using a classifier-based approach.

Note that the operations and functions shown in or described with respect to FIGS. 2 through 21 can be implemented in an electronic device 101, 102, 104, server 106, or other device(s) in any suitable manner. For example, in some embodiments, the operations and functions shown in or described with respect to FIGS. 2 through 21 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 21 can be implemented or supported using dedicated hardware components. In general, the operations and functions shown in or described with respect to FIGS. 2 through 21 can be performed using any suitable hardware or any suitable combination of hardware and software/firmware instructions. Also note that the operations and functions shown in or described with respect to FIGS. 2 through 21 can be implemented using one device or multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
adding an outpaint mask to an image to generate a masked image;
processing the image using an encoder neural network to generate an image representation of the image in a latent space;
processing the masked image using a convolution neural network and adding the image representation to generate an image embedding;
processing the image representation and the image embedding using at least one of a diffusion model and an interpolation process to generate a noisy latent image representation;
using a large language model to contextualize an outpainting prompt;
denoising the noisy latent image representation based on the contextualized outpainting prompt to generate a denoised latent image representation; and
processing the denoised latent image representation using a decoder neural network to generate an outpainted image.

2. The method of claim 1, wherein a multilabel classifier is employed to contextualize the outpainting prompt.

3. The method of claim 1, wherein denoising the noisy latent image representation is based on one or more personalization features.

4. The method of claim 1, wherein:
the masked image is processed multiple times using an outpainting model; and
the outpainting model comprises the encoder neural network, the convolution neural network, the diffusion model, the large language model, and the decoder neural network.

5. The method of claim 1, further comprising:
detecting an image quality of the outpainted image; and
reprocessing the outpainted image based on the detected image quality.

6. The method of claim 5, wherein detecting the image quality of the outpainted image comprises:
processing a linear projection of image patches of the outpainted image using a transformer encoder;
processing an output of the transformer encoder using a multi-layer perceptron (MLP); and
applying a sigmoid function to an output of the MLP.

7. The method of claim 5, wherein detecting the image quality of the outpainted image comprises:
using a generative adversarial network (GAN) that includes (i) a generator configured to generate negative training examples and (ii) a discriminator trained on the negative training examples.

8. An electronic device comprising:
at least one processing device configured to:
add an outpaint mask to an image to generate a masked image;
process the image using an encoder neural network to generate an image representation of the image in a latent space;
process the masked image using a convolution neural network and add the image representation to generate an image embedding;
process the image representation and the image embedding using at least one of a diffusion model and an interpolation process to generate a noisy latent image representation;
use a large language model to contextualize an outpainting prompt;
denoise the noisy latent image representation based on the contextualized outpainting prompt to generate a denoised latent image representation; and
process the denoised latent image representation using a decoder neural network to generate an outpainted image.

9. The electronic device of claim 8, wherein the at least one processing device is configured to employ a multilabel classifier to contextualize the outpainting prompt.

10. The electronic device of claim 8, wherein the at least one processing device is configured to denoise the noisy latent image representation based on one or more personalization features.

11. The electronic device of claim 8, wherein:
the at least one processing device is configured to process the masked image multiple times using an outpainting model; and
the outpainting model comprises the encoder neural network, the convolution neural network, the diffusion model, the large language model, and the decoder neural network.

12. The electronic device of claim 8, wherein the at least one processing device is further configured to:
detect an image quality of the outpainted image; and
reprocess the outpainted image based on the detected image quality.

13. The electronic device of claim 12, wherein, to detect the image quality of the outpainted image, the at least one processing device is configured to:
process a linear projection of image patches of the outpainted image using a transformer encoder;
process an output of the transformer encoder using a multi-layer perceptron (MLP); and
apply a sigmoid function to an output of the MLP.

14. The electronic device of claim 12, wherein, to detect the image quality of the outpainted image, the at least one processing device is configured to use a generative adversarial network (GAN) that includes (i) a generator configured to generate negative training examples and (ii) a discriminator trained on the negative training examples.

15. A method comprising:
performing a neural network architecture search using a noisy image and an initial student model to select a neural network architecture for an output student model, the neural network architecture for the output student model selected according to a proxy prediction model based on a teacher model and the noisy image;
quantizing weights of the output student model, wherein outlier weights are quantized with a first precision higher than a second precision utilized for quantizing remaining weights other than the outlier weights, and wherein the outlier weights are identified using a calibration dataset; and
clustering the weights of the output student model, wherein each neuron of a weight matrix for the output student model is represented by an integer cluster index for a centroid of clustered weights including a weight for the neuron.

16. The method of claim 15, wherein:
the output student model is a first student model;
weights of the teacher model are frozen; and
the method further comprises:
concatenating a prediction output by a second student model having the neural network architecture with the noisy image for use as an input to the teacher model; and
concatenating a prediction output by the teacher model with the input to the teacher model for use as an input to the proxy prediction model, wherein the proxy prediction model is trained to minimize loss by the first student model relative to the teacher model.

17. The method of claim 16, wherein the second student model operates at a timestamp later than the first student model.

18. The method of claim 16, wherein weights of the first student model and the second student model are fine-tuned by freezing weight matrices of the respective model and adding additional weight matrices that are a low rank decomposition of the frozen weight matrices.

19. The method of claim 15, wherein identifying the outlier weights using the calibration dataset is performed iteratively and layer by layer.

20. The method of claim 15, wherein identifying the outlier weights comprises:
quantizing a column of a weight matrix;
determining whether an L2 norm difference for the quantized column of the weight matrix exceeds a threshold; and
in response to determining that the L2 norm difference for the quantized column of the weight matrix exceeds the threshold, individually quantizing weights of the quantized column.
